(19) United States
(12) Patent Application Publication
(10) Pub. No.: US 2008/0258482 A1
(43) Pub. Date: Oct. 23, 2008

(54) Automatic side door protector

(76) Inventor: Charles Udolph, Encino, CA (US)

Correspondence Address: Cislo & Thomas LLP, 1333 2nd Street, Suite #500, Santa Monica, CA, 90401-4110, US

(21) Appl. No.: 12/214,729

(22) Filed: Jun. 20, 2008

Related U.S. Application Data
(63) Continuation-in-part of application No. 11/595,772, filed on Nov. 10, 2006.

(51) Int. Cl. B60R 19/42

(52) U.S. Cl. 293/128

(57) ABSTRACT

An automatic side door protector having a protective pad and a support strap. The protective pad is preferably planar and rectangular, and each of the four corners of the rectangle is rounded. The protective pad is divided into multiple segments. Each of the segments is pivotally connected to at least one adjacent segment, permitting the device to be folded along the pivotal connections into a folded configuration. The support strap is connected to the protective pad at a peripheral edge of the protective pad. The support strap has a rolled end preferably formed by rolling the end of the support strap over itself. Preferably, at least one magnet is connected to each of the segments for securing the device to a magnetic surface and at least two suction cups attached to the protective pad help secure the device to the side of the vehicle.

### CROSS-REFERENCES TO RELATED APPLICATIONS

This patent application is a continuation-in-part of and claims the benefit of U.S. patent application Ser. No. 11/595,772 filed Nov. 10, 2006 for Automatic Side Door Protector, which application is incorporated here by this reference.

### TECHNICAL FIELD

This invention relates to protective devices that minimize damage to the sides of vehicles from scratches, dings, and dents.

### BACKGROUND ART

It is a frequent occurrence that a vehicle, especially when parked in a parking lot, is subject to being damaged by the doors or occupants of vehicles in adjacent parking spots. Those other occupants may be unaware that their vehicle doors, their shopping carts, or they themselves are causing the other vehicle to be scratched, dinged, dented, or otherwise damaged. As such, there exists a need for a device to protect the doors and sides of vehicles from that damage.

A number of previous devices have been created to address this problem. However, those devices are often cumbersome to use, not adjustable for a variety of vehicles, or not theft resistant. Therefore, there exists a need for a protective device that is lightweight, easy to install onto the vehicle, and easy to store. There also exists a need for a protective device that is easily adjusted to fit a variety of vehicle sizes and that is resistant to being removed from the vehicle by someone other than the vehicle's owner.

Moreover, none of the existing devices can be easily installed on vehicles made of a variety of materials, both magnetic and non-magnetic.

### DISCLOSURE OF INVENTION

The present invention is directed to an easy to use, compact device for protecting the sides of a vehicle from damage such as scratches, dings, and dents. The invention provides an automatic side door protector being a foldable, securable device having a protective pad and a support strap. The protective pad is preferably planar and rectangular, and each of the four corners of the rectangle is rounded. The protective pad is divided into multiple segments. Each of the segments is pivotally connected to an adjacent segment, permitting the device to be folded along the pivotal connections into a folded configuration.

The support strap is connected to the protective pad at a peripheral edge of the protective pad and has a rolled end that is preferably formed by rolling the end of the support strap over itself.

Preferably, at least one magnet is connected to each of the segments for securing the automatic side door protector to a magnetic surface and at least two suction cups attached to the protective pad help secure the protective device to the side of the vehicle. As a result, the magnets and the suction cups allow the automatic side door protector to be mounted on variously sized vehicles and those made of various materials, such as aluminum or plastic. No other existing door protector has this functionality.

The support strap may also include both a hook portion and a loop portion of a hook-and-loop fastener, where the hook portion and the loop portion are located on the support strap such that the support strap may be wrapped around the protective pad in the folded configuration and the hook portion may engage the loop portion for compact storage of the automatic side door protector.

### BRIEF DESCRIPTION OF DRAWINGS

FIG. 1 is a plan view of an embodiment of an automatic side door protector.

FIG. 2 depicts an embodiment of an automatic side door protector installed on a vehicle.

FIG. 3 is a side view of a rolled end of an embodiment of an automatic side door protector.

FIG. 4 is a side view of a rolled end of an embodiment of an automatic side door protector.

### BEST MODE FOR CARRYING OUT THE INVENTION

The detailed description set forth below in connection with the appended drawings is intended as a description of presently-preferred embodiments of the invention and is not intended to represent the only forms in which the present invention may be constructed or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

Referring to the figures, the automatic side door protector 100 has a protective pad 102 and a support strap 104. The support strap 104 is connected to the protective pad 102 at one or more places, though preferably at one central place.

The protective pad 102 is preferably planar and rectangular, and some embodiments have rounded corners to minimize wind resistance. The protective pad 102 is preferably divided into multiple segments. In such versions, each of the segments is preferably pivotally connected to one or more adjacent segments, permitting the segments to be folded against each other. This allows the automatic side door protector 100 to be made compact for storage, for example, in a vehicle's trunk.

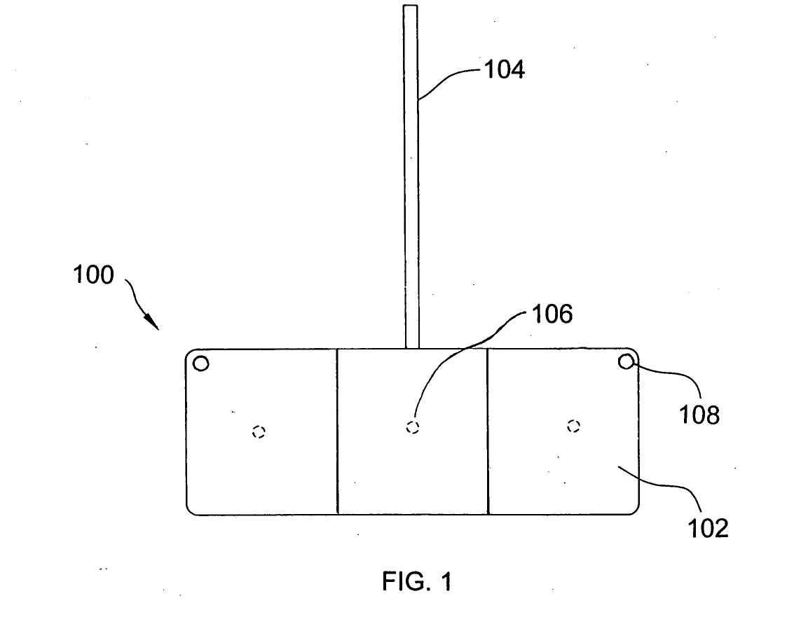

In some embodiments, the protective pad 102 may have one or more magnets 106 to assist in securing the automatic side door protector 100 to a magnetic surface, such as a vehicle's door. The one or more magnets 106 may be attached to the protective pad 102 or the magnets may be internal to the protective pad 102. Some versions also may have one or more suction cups 108 to help secure the automatic side door protector 100 to a vehicle. The magnets 106 and the suction cups 108 help to make the automatic side door protector 100 universal and capable of being mounted on variously sized vehicles and those made of various materials, such as aluminum, plastic, fiberglass, metal, or other materials. In a preferred version, the automatic side door protector 100 has three magnets 106 and two suction cups 108 arranged as depicted in FIG. 1.

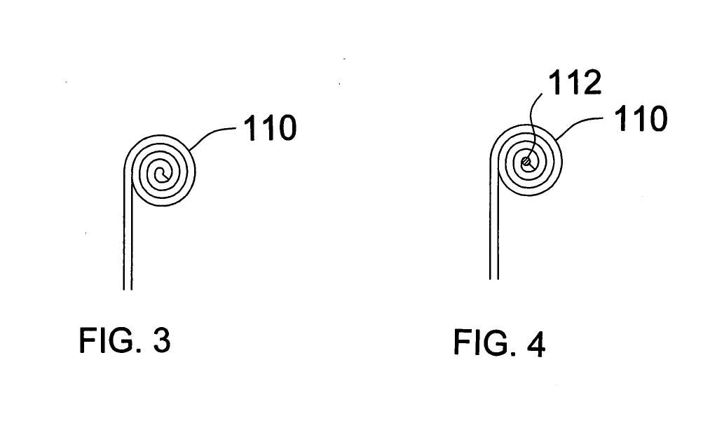

Referring to FIG. 3, the automatic side door protector 100 is installed on the vehicle to be protected by inserting the support strap 104 either between a window and the window frame or between the door and the door frame. The window or door is closed onto the support strap 104, securing it by pinching the support strap 104 between the window and the window frame or between the door and the door frame, respectively. The automatic side door protector 100 is height adjustable by varying the length of the support strap 104 that is inside of the vehicle when the support strap 104 is pinched by the window or door. Where more of the support strap 104 is inside of the vehicle, the protective pad 102 is generally higher up on the side of the vehicle than when less of the support strap 104 is inside of the vehicle. The automatic side door protector 100 is also positionable laterally by varying the side-to-side location in the door frame or window frame where the support strap 104 is pinched. Therefore, the automatic side door protector 100 is adaptable to various vehicle types. Further, the structure of the device permits the automatic side door protector 100 to be installed on just one side of the vehicle, if desired. The overall dimensions of a version of the invention permit a single automatic side door protector 100 to protect both doors on one side of the vehicle, although the automatic side door protector 100 can be positioned to protect a single door, too.

To deter theft of the automatic side door protector 100, the support strap 104 further has an enlarged end 110. The end is enlarged in that its thickness is generally greater than the thickness of the remainder of the support strap 104. The enlarged end 110 helps to prevent the support strap 104 from being pulled back through the closed window or door of the vehicle. The enlarged end 110 can be formed, for example, by rolling, turning, or curling the end of the support strap 104 over itself or by wrapping the support strap 104 around an anchor object 112. Preferably, the enlarged end 110 is formed by rolling, turning, or curling the end of the support strap 104 over itself at least three or four times, without including an anchor object 112.

The enlarged end may also be formed by attaching an anchor object 112 to the support strap 104, where the width of the anchor object is greater than the thickness of the support strap 104. The anchor object 112 may be of any size or shape, provided the support strap 104 can be wrapped around the anchor object 112 or the anchor object 112 can be attached to the support strap 104, either on the inside or the outside of the end of the support strap 104.

The support strap 104 may also include a hook-and-loop fastener. Both the hook portion and the loop portion of the fastener are preferably located on the support strap 104 such that the support strap 104 may be wrapped around the protective pad 102 after the segments of the protective pad 102 are folded against each other, while the hook portion engages the loop portion for compact storage of the automatic side door protector 100.

To provide a long-lasting device, the protective pad 102 is preferably made of a highly durable material that is resistant to weather, heat, and water. Such materials include, but are not limited to, plastics; laminated wood or cardboard; and felt-covered plastic, metal, wood, and cardboard. Other materials can also be successfully used.

The automatic side door protector 100 as described may be mounted to a vehicle by opening a window or a door of the vehicle and feeding the enlarged end 110 of the support strap 104 through the vehicle's open window or over an edge of the open door, whichever is desired. The protective pad 102 of the automatic side door protector 100 remains outside of the vehicle, generally parallel to a side of the vehicle. The user then may optionally increase or decrease the length of the support strap 104 that is fed through the vehicle's open window or over the edge of the open door such that the protective pad 102, hanging from the support strap 104, is accurately positioned on the outside of the vehicle.

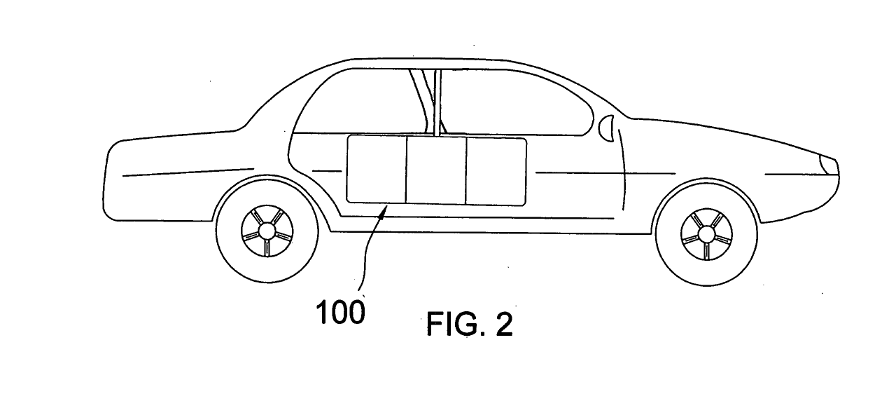

After the protective pad 102 is positioned, the user closes the vehicle's window or the vehicle's door so that the support strap 104 is pinched between the vehicle's window and a window frame or between the vehicle's door and a door frame, respectively. As a result, the enlarged end 110 of the support strap 104 is inside of the vehicle and the protective pad 102 is hanging outside of the vehicle from the pinched support strap 104. The enlarged end 110 of the support strap 104 helps to prevent the support strap 104 from being pulled back through the closed window or door of the vehicle. An example of an installed automatic side door protector 100 is shown in FIG. 2.

The user removes and folds the automatic side door protector 100 by opening the vehicle's window or the vehicle's door so that the support strap 104 is released from between the vehicle's window and the window frame or from between the vehicle's door and the door frame, respectively. The user then folds the segments of the protective pad 102 along the pivotal connections into a folded configuration and wraps the support strap 104 around the folded segments. The user then secures the support strap 104 around the folded segments by connecting the hook-and-loop fastener of the support strap 104.

While the present invention has been described with regard to particular embodiments, it is recognized that additional variations of the present invention may be devised without departing from the inventive concept.

### INDUSTRIAL APPLICABILITY

This invention may be industrially applied to the development, manufacture, and use of protective devices that minimize damage to the sides of vehicles from scratches, dings, and dents.

What is claimed is:

1. A foldable, securable device for protecting a side of a vehicle from damage such as scratches, dings, and dents, the device comprising:
(a) a protective pad, the protective pad being generally planar and rectangular, each of the four corners of the rectangle being rounded, the protective pad being divided into three segments where each of the segments is pivotally connected to at least one other of the segments, permitting the device to be folded along the pivotal connections into a folded configuration, the protective pad being formed from a weather resistant material;
(b) a support strap, the support strap being connected to the protective pad at a peripheral edge of the protective pad, the support strap further having a rolled end formed by rolling the end of the support strap over itself at least three times;
(c) at least one magnet connected to each of the three segments for securing the device to a magnetic surface;
(d) at least two suction cups for securing the device to the side of the vehicle; and
(e) the support strap further comprising both a hook portion and a loop portion of a hook-and-loop fastener, the hook portion and the loop portion being located on the support strap such that the support strap may be wrapped around the protective pad in the folded configuration and the hook portion engages the loop portion for compact storage of the device.

2. The device of claim 1, the at least one magnet being internal to and centrally positioned within the segment.

3. The device of claim 1, one of the suction cups being positioned at an upper corner of the protective pad and another of the suction cups being positioned at another upper corner of the protective pad.

4. A method of using a foldable, securable vehicle door protector, the method comprising the steps of:
(a) providing a vehicle door protector, the vehicle door protector having:
(i) a protective pad, the protective pad being generally planar and rectangular, each of the four corners of the rectangle being rounded, the protective pad being divided into three segments where each of the segments is pivotally connected to at least one other of the segments, permitting the device to be folded along the pivotal connections into a folded configuration, the protective pad being formed from a weather resistant material;
(ii) a support strap, the support strap being connected to the protective pad at a peripheral edge of the protective pad, the support strap having a rolled end formed by rolling the end of the support strap over itself at least three times;
(iii) at least one magnet connected to each of the three segments for securing the device to a magnetic surface; and
(iv) at least two suction cups for securing the device to the side of the vehicle;
(b) mounting the vehicle door protector to the vehicle by:
(i) opening a window or a door of the vehicle;
(ii) feeding the enlarged end of the support strap through the vehicle's open window or over an edge of the open door, the protective pad of the vehicle door protector remaining outside of the vehicle, generally parallel to a side of the vehicle;
(iii) increasing or decreasing a length of the support strap that is fed through the vehicle's open window or over the edge of the open door such that the protective pad of the vehicle door protector, hanging from the support strap, may be accurately positioned on the outside of the vehicle;
(iv) closing the vehicle's window or the vehicle's door so that the support strap is pinched between the vehicle's window and a window frame or between the vehicle's door and a door frame, respectively, the enlarged end being inside of the vehicle and the protective pad of the vehicle door protector hanging outside of the vehicle from the pinched support strap, the enlarged end of the support strap helping to prevent the support strap from being pulled back through the closed window or door of the vehicle; and
(v) affixing the magnets, suction cups, or both to the vehicle's door to secure the vehicle door protector.

5. The method of claim 4 further comprising the step of removing and folding the vehicle door protector by:
(i) opening the vehicle's window or the vehicle's door so that the support strap is released from between the vehicle's window and the window frame or between the vehicle's door and the door frame, respectively;
(ii) folding the segments along the pivotal connections into a folded configuration; and
(iii) wrapping the support strap around the folded segments; and
(iv) securing the support strap around the folded segments by connecting the hook-and-loop fastener.

6. A device for protecting the sides of a vehicle from damage such as scratches, dings, and dents, the device comprising:
(a) a protective pad, the protective pad being generally planar, the protective pad being divided into a plurality of segments where each of the plurality of segments is pivotally connected to at least one other of the plurality of segments, permitting the device to be folded along the pivotal connection, the protective pad being formed from a weather resistant material; and
(b) a support strap, the support strap being connected to the protective pad at a peripheral edge of the protective pad, the support strap further having a rolled end formed solely by rolling the end of the support strap over itself one or more times.

7. A method of protecting a door of a vehicle and of deterring theft of a vehicle door protector, comprising the steps of:
(a) providing a vehicle door protector, the vehicle door protector having:
(i) a protective pad, the protective pad having a peripheral edge; and
(ii) a support strap, the support strap having an attachment end a enlarged end, the attachment end being connected to the peripheral edge of the protective pad, the enlarged end of the support strap being formed by turning the enlarged end of the support strap over itself at least one time;
(b) mounting the vehicle door protector to the vehicle by:
(c) opening a window or a door of the vehicle;
(d) feeding the enlarged end of the support strap through the vehicle's open window or over an edge of the open door, the protective pad of the vehicle door protector remaining outside of the vehicle, generally parallel to a side of the vehicle;
(e) closing the vehicle's window or the vehicle's door so that the support strap is pinched between the vehicle's window and a window frame or between the vehicle's door and a door frame, respectively, the enlarged end being inside of the vehicle and the protective pad of the vehicle door protector hanging outside of the vehicle from the pinched support strap, the enlarged end of the support strap helping to prevent the support strap from being pulled back through the closed window or door of the vehicle.

8. The method of claim 7, further comprising the step of, prior to closing the vehicle's window or the vehicle's door, increasing or decreasing a length of the support strap that is fed through the vehicle's open window or over the edge of the open door such that the protective pad of the vehicle door protector, hanging from the support strap, may be accurately positioned on the outside of the vehicle.

9. The method of claim 7, the enlarged end of the provided support strap being formed by turning the enlarged end of the support strap over upon itself at least one time.

10. The method of claim 7, the enlarged end of the provided support strap being formed by attaching an anchor object to the support strap.
